(19) United States
(12) Patent Application Publication
(10) Pub. No.: US 2013/0056509 A1
(43) Pub. Date: Mar. 7, 2013

(54) BOARD MOUNTABLE PADDLE RETAINING DEVICE

(71) Applicant: Justin Fuller, Laguna Beach, CA (US)

(72) Inventor: Justin Fuller, Laguna Beach, CA (US)

(21) Appl. No.: 13/225,955

(22) Filed: Sep. 6, 2011

(51) Int. Cl. B60R 7/00

(52) U.S. Cl. 224/406

(57) ABSTRACT

Provided is a paddle retaining device which may be easily mounted to a stand-up paddle board, wherein the paddle retaining device is specifically configured and adapted to allow a user to quickly and easily securing the paddle to the board. The paddle retaining device may be attached to the board without significantly interfering with the structure and integrity of the paddle surfboard. Along these lines, the paddle retaining device may be secured to the board without drilling holes or making other material modifications to the structure of the paddle surfboard.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

1. Field of the Invention

The present invention relates to a device for retaining a paddle adjacent a paddle surfboard during nonuse of the paddle.

2. Description of the Related Art

Recreational water boards have taken a variety of forms throughout the years, including those propelled along the surface of bodies of water by a mechanical device. In particular, the sport of stand-up paddle surfing originated several years ago, although it has recently experienced rising growth and popularity around the world. The sport generally requires a suitably configured board and a paddle. The board is generally configured similar to a conventional surfboard, with the primary distinction being that the stand-up paddle board is slightly larger in length, width and thickness than the conventional surfboard. The paddle typically includes a blade at one end, and a handle at the opposing end, with an elongate shaft extending therebetween.

Although the paddle is typically essential for propelling the board, there are times when using the board that the paddle is not used. For instance, when the user enters the body of water, especially if the body of water is an ocean, the user may kneel or lay on the board and paddle with his hands until the user is through the breaking surf. Furthermore, when the user is on the board in calm waters, the user may perform exercises on the board, such as yoga. In addition, after stand-up paddle session, the user oftentimes is required to carry his board and paddle back to his house or to his car. Given the large and bulky nature of both the paddle and the board, it is difficult to carry both items, especially if they are not connected to each other.

A common difficulty associated with stand-up paddling arises when the paddle is not being used because there is generally nowhere to easily stow the paddle. Thus, in the situation described above wherein the user is paddling with his hands when launching the paddle board, the user may kneel or lie on the paddle to ensure that the paddle does not fall overboard. Likewise, when the user is performing exercises on the board, the user may lie the paddle on the board while performing the exercises. However, the board may rock causing the paddle to fall off, or the paddle may get in the way of the individual performing the exercises.

As is apparent from the foregoing, there exists a need in the art for a paddle retaining device that can be easily attached to the stand-up paddle board without significantly altering the structure of the beard. The present invention addresses this particular need, as will be discussed in more detail below.

### BRIEF SUMMARY OF THE INVENTION

According to an aspect of the present invention, there is provided a paddle retaining device which may be easily mounted to a stand-up paddle board, wherein the paddle retaining device is specifically configured and adapted to allow a user to quickly and easily securing the paddle to the board. The paddle retaining device may be attached to the board without significantly interfering with the structure and integrity of the paddle surfboard. Along these lines, the paddle retaining device may be secured to the board without drilling holes or making other material modifications to the structure of the paddle surfboard.

According to one embodiment, the paddle retaining device includes a resilient body having a first end portion and a second end portion. An inlet channel is formed within the resilient body extending from the first end portion toward the second end portion. The inlet channel is moveable between an expanded position and a retracted position, wherein the size of the inlet channel increases as the inlet channel moves from the retracted position to the expanded position. The resilient body further includes a paddle retaining channel in communication with the inlet channel, with the paddle retaining device being sized to receive a portion of the paddle.

The paddle retaining device may be formed from a resilient material to allow a paddle to be easily inserted into the paddle retaining channel through the inlet channel. Along these lines, it is contemplated that the device may be configured and adapted to allow a user to insert the paddle into the device using only one hand.

The paddle retaining device may be formed from a material, such as rubber, which is capable of withstanding long exposure to water, exhibits resilient qualities to enable operation of the device, and also does not raise significant safety concerns, such as if a paddle surfer were to fall onto the device.

The present invention is best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings in which like numbers refer to like parts throughout and in which:

FIG. 1 is a perspective view of a user on a paddle surfboard and a pair of paddle retaining devices mounted to the surfboard for securing the paddle during nonuse;

FIG. 2 is a partial upper perspective view of the paddle retained within the pair of paddle retaining devices;

FIG. 3 is an upper perspective view of the paddle retaining device;

FIG. 4 is a front sectional view of the paddle retaining device;

FIG. 5 is an upper perspective view of a second embodiment of the paddle retaining device coupled to a support mat connected to the paddle surfboard; and

FIG. 6 is an upper perspective view of the paddle retaining device depicted in FIG. 5.

Common reference numerals are used throughout the drawings and detailed description to indicate like elements.

### DETAILED DESCRIPTION OF THE INVENTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments am' that they are also intended to be encompassed within the scope of the invention.

Referring now to the drawings wherein the showings are for purposes of illustrating preferred embodiments of the present invention, and not for purposes of limiting the same, there is shown a paddle retaining device 10 configured to retain a paddle 12 adjacent a paddle surfboard 14 when the user is not using the paddle 12.

During a normal paddle-boarding session, the user stands on the paddle surfboard 14 and uses the paddle 12 to propel the user along the water. However, there are occasions when the user is on the board 14 when the paddle 12 is not being used. For instance, when the user initially launches the board 14, the user may lie on the board 14 and paddle through the crashing waves with his hands, similar to traditional surfing. Paddle surfers may also perform exercises, such as yoga, on their board 14 when they are out on the water. During those times, the user is not using the paddle 12 and either holds the paddle 12 in one hand, or more likely, tries to rest the paddle 12 on the board 14, which typically results in the paddle 12 falling off the board 14 and into the water.

The paddle retaining device 10 is specifically configured and adapted to allow the user to stow the paddle 12 adjacent the board 14 when the paddle 12 is not being used during the paddle-board session. Furthermore, when the user is done with the paddle-board session, the user may stow the paddle 12 adjacent the board 14 to facilitate carrying of the paddle 12 and the board 14 to the destination.

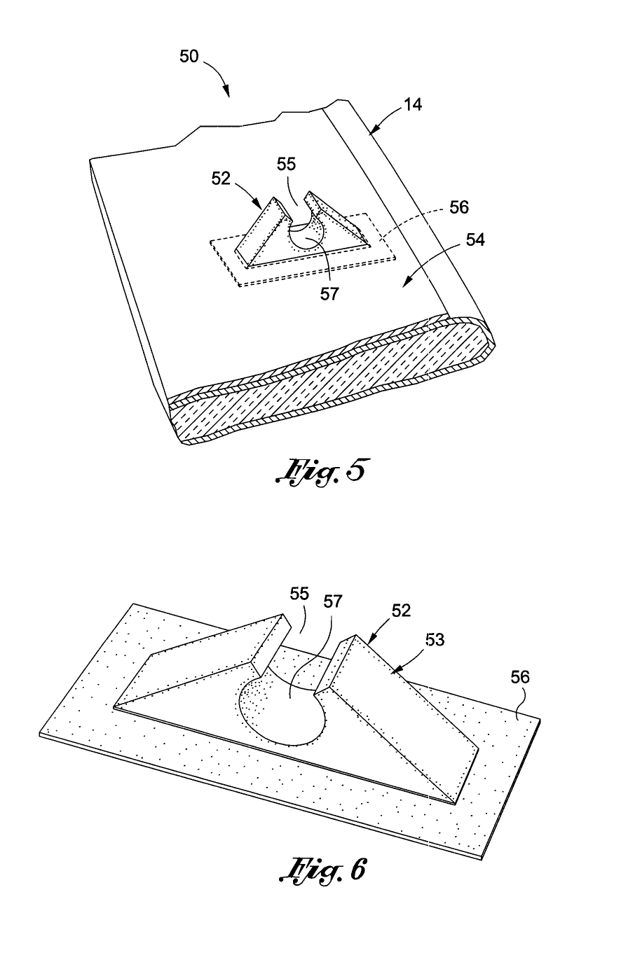

Referring now specifically to FIGS. 3 and 4, one embodiment of the device 10 is shown with the device 10 including a resilient body 16 having a first end portion 18 and an opposing second end portion 20. The resilient body 16 further includes a front face 22, an opposing rear face 24, a first side face 26, a second side face, and an end face 30. The resilient body 16 depicted in the Figures defines a generally triangular configuration, with the first and second side faces 26, 28 being angled toward each other such that the distance between the first and second side faces 26, 28 decreases from the second end portion 20 toward the first end portion 18. In other words, the resilient body 16 may define acute angles between the end face 30, and the first and second side faces 26, 28.

The resilient body 16 additionally includes an inlet channel 32 and a stowing channel 34, both of which extend from the front face 22 to the rear face 24. The inlet channel 32 is defined by a first inlet face 36 and the second inlet face 38. The stowing channel 34 is defined by an inner face 40. The first inlet face 36 extends between the first side face 26 and the inner face 40 and the second inlet face 38 extends between the second side face 28 and the inner face 40. In this regard, the inner face 40 extends between the first inlet face 36 and the second inlet face 38.

The inlet channel 32 communicates with the stowing channel 34 to allow a user to insert the paddle handle into the stowing channel 34 via the inlet channel 32. Along these lines, the distance between the first inlet face 36 and the second inlet face 38 defines an inlet channel width, “W,” and tie inner face 40 defines a stowing diameter, “D.” In a preferred embodiment, at least a portion of the inlet channel width, W is less than the stowing diameter D, which allows the paddle shaft to be captured or restrained within the stowing channel 34 once the paddle shaft passes through the inlet channel 32.

According to one implementation of the present invention, the inlet channel 32 is tapered such that the inlet channel width W decreases in a direction from the first end portion 18 toward the second end portion 20. The tapered configuration may facilitate insertion of the paddle handle into the device 10.

The resilient body 16 is configured to allow the inlet channel 32 to expand during insertion or removal of the paddle 12 in to, or out of, the stowing channel 34, and then to retract to its initial configuration after the paddle 12 is either disposed within the stowing channel 34 or removed from the device 10. In this regard, the resilient body 16 is transitional between an expanded position and a retracted position during usage of the device 10. The inlet channel width W increases as the resilient body 16 moves from the retracted position toward the expanded position, and decreases as the resilient body 16 moves from the expanded position toward the retracted position. The resilient body 16 may be biased toward the retracted position, such that body 16 is urged toward the retracted position when the body 16 is moved into the expanded position. Furthermore, the body 16 may transition between the expanded and retracted positions without being permanently deformed.

It is contemplated that the size of the inlet channel 32 and stowing channel 34 is configured to be commensurate in size with the shaft portion of the paddle 12. More specifically, the narrowest portion of the inlet channel width W and the radius of the stowing channel 34 are preferably sized to be slightly less than the shaft portion of the paddle 12 when the inlet channel width W is in the retracted position. Paddles 12 are commonly sold having shaft portions that are approximately 1⅛″. Thus, one embodiment of the body includes a stowing channel 34 that defines a ½″ radius when the stowing channel 34 is in the retracted position.

According to one embodiment, the end face 30 may define a length L extending between the first and second side faces 26, 28 of approximately 3 11/16″. The first and second side faces 26, 28 may extend from the end face 30 to define an internal angle of approximately 40 degrees. The device 10 may defined a height “H” as the dimension extending generally perpendicularly from the end face 30. According to one embodiment, the height H may be approximately 1 9/16″. The depth “D” of the device 10 may be defined as the distance between the front and rear faces 22, 24, and in one embodiment, may be approximately equal to 1½″. The first and second inlet faces 36, 38 may define a dimension of approximately ½″ between the respective one of the first and second side faces 26, 28 and the inner face 40. Furthermore, the first and second inlet faces 36, 38 may define respective planes that are approximately 48 degrees from a plane defined by the end face 30.

Those skilled in the art will readily appreciate that the dimensions provides above are exemplary in nature only and are not intended to limit the scope of the present invention. Along these lines, the device 10 may define other shapes, sizes, and configurations without departing from the spirit and scope of the present invention. For instance, the generally triangular shape and configuration shown in the figures is intended to be exemplary in nature only and is not intended limit the scope and content of the present invention. In this regard, the resilient body 16 may define other shapes, such as a quadrangle, circle, etc.

The body 16 is further configured to be mountable to the paddle surfboard 14. To this end, the body 16 may include an adhesive layer 42 disposed on the end face 30, wherein the adhesive layer 42 connects the body 16 to the paddle surfboard 14. The adhesive layer 42 may be covered by a peel-off layer 44, which is removed to expose the adhesive layer 42 to mount the device 10 on the paddle surfboard 14. The adhesive layer 42 is preferably configured to withstand long exposure to freshwater and/or saltwater without losing its adhesive properties.

The adhesive layer advantageously connects the body 16 to the paddle surfboard 14, while at the same time mitigating damage to the board 14. Mounting holes or other permanent modifications to the board 14 are typically not required to mount the body 16 to the board 14. As such, the device 10 is a desirable alternative to other paddle retaining devices which may exist, but the usage of such devices may require damage to the board 14, such as a mounting aperture.

Although the foregoing describes an adhesive layer 42 for connecting the body 16 to the board 14, those skilled in the art will appreciate that other mechanical fastening devices, such as a strap, may be used without departing from the spirit and scope of the present invention.

The resilient body 16 is preferably formed from a resilient material configured to withstand extended and repeated exposure to saltwater, freshwater, and UV rays. Exemplary materials include ethylene vinyl acetate (EVA), rubber, foam, or other materials known by those skilled in the art. Furthermore, the resilient nature of the material enhances the overall safety of the device 10, such that if a user were to inadvertently fall onto the device 10, the generally soft and resilient nature of the body 16 would mitigate injury to the user.

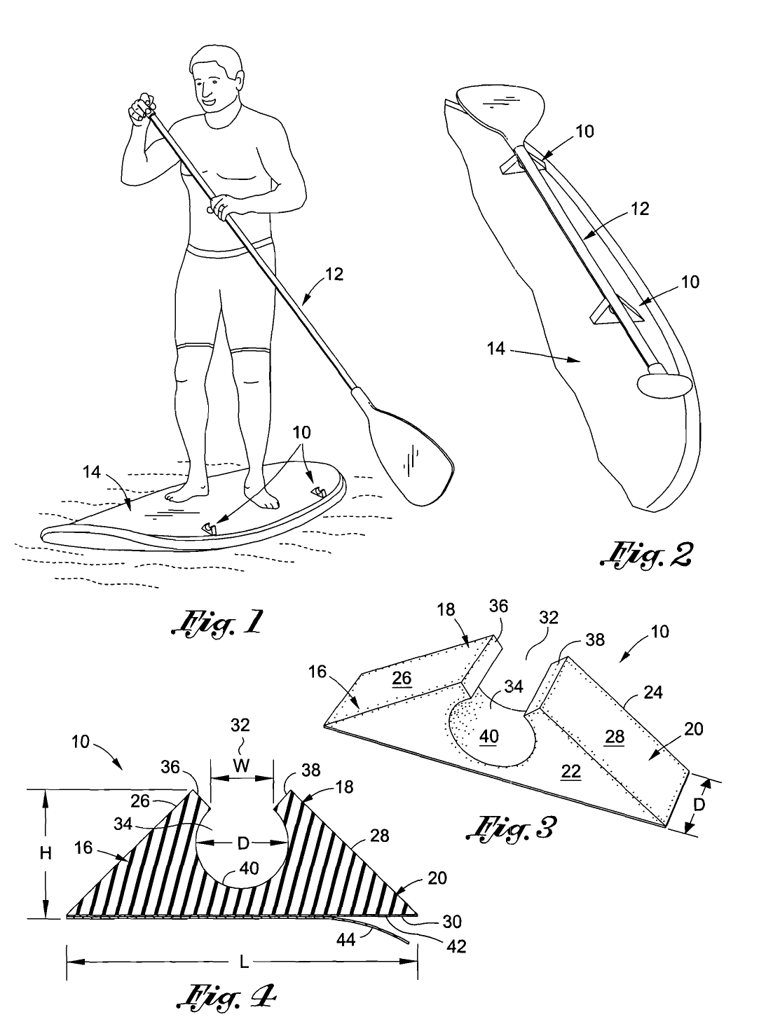

Referring now specifically to FIGS. 5-6, there is shown another embodiment of the present invention, which includes a retaining unit 50 comprised of a retaining device 52 coupled to a support mat 54. The support mat 54 is similar to conventional support mats 54 commonly used on stand-up paddle surfboards 14 to enhance the traction as the user stands on the board 14. The support mat 54 may be formed from EVA, rubber, foam, or other materials known in the art. The support mat 54 may include an adhesive on its bottom surface for securing the support mat 54 to the paddle surfboard 14. The retaining device 52 is similar to the retaining device 10 described above and shown in FIGS. 1-4, with the primary distinction being the retaining device 50 is coupled to the support mat 52. In this regard, the retaining device 52 includes a resilient body 53 defining an inlet channel 55 and a stowing channel 57 for receiving and stowing a paddle. The resilient body 53 is transitional between an expanded position and a retracted position to allow for insertion and removal of the paddle to and from the device 52.

According to one implementation, the retaining device 52 is integrally formed with the support mat 54. Along these lines, the retaining device 52 and support mat 54 may be formed from a molding process, which produces a single retaining unit 50, wherein the retaining device 52 is integral with the support mat 54 to define a unitary structure. The retaining unit 50 preferably includes at least two retaining devices 52 formed with the support mat 54, wherein the retaining devices 52 are coaxially aligned with each other adjacent a lateral end portion of the mat 54. However, other embodiments may only include a single retaining device 52, which may be located anywhere on the mat 54.

According to another embodiment, the retaining device 52 may be fastened to the support mat 54 via mechanical fastening techniques. Referring now specifically to FIGS. 5 and 6, the retaining device 52 may include an attachment flap 56 extending radially outward therefrom. The attachment flap 56 may be used to secure the retaining device 52 to the support mat 54. For instance, in one embodiment, the support mat 54 includes several layers which are vertically stacked to define the support mat 54. The upper layer(s) of the support mat 54 may include an opening sized to allow the retaining device 52 to be advanced therethrough, while the attachment flap 56 resides between adjacent layers of the support mat 54. The attachment flap 56 may be stitched, welded, adhered or otherwise secured to one or both of the adjacent support mat layers. In another embodiment, the opening formed within the support mat 54 may extend completely through the thickness of the support mat 54, i.e., through all of the layers, such that the attachment flap 56 resides between the board 14 and the support mat 54 when the retaining device 52 is advanced through the opening. Along these lines, the bottom surface of the attachment flap 56 may include a gripping surface or an adhesive to enhance the traction between the attachment flap 56 and the paddle surfboard 14 to mitigate slippage therebetween.

It is also contemplated that the retaining device 52 and support mat 54 may be configured to allow for selective attachment/detachment of the retaining device 52 to/from the support mat 54. For instance, the retaining device 52 and support mat 54 may include complimentary snap fasteners, hook and loop fasteners, or other fasteners known by those skilled in the art to connect the retaining device 52 to the support mat 54.

Those skilled in the art will readily appreciate that although the foregoing describes embodiments of a retaining device 10, 52 for a paddle on a stand-up paddle surfboard 14, other embodiments of the retaining device may be used for other purposes. For instance, the retaining device may be used in the nautical industry as a guide or clip for lanyard or line. Along these lines, the lanyard or line may be advanced through the inlet channel 32 and into the stowing channel 34 to guide the lanyard/line through the retaining device. It is also contemplated that various aspects of the retaining device may be used as a storage or organizing device, such as to store tools/utensils in a user's garage or kitchen. The foregoing provides exemplary uses of various embodiments of the retaining device, although it is understood that the examples are illustrative in nature only, and do not limit the scope of the retaining devices 10, 52.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combinations described herein. Thus, the scope of the claims is not to be limited by the illustrated embodiments.

What is claimed is:

1. A support mat and paddle retaining device for use with a paddle and a paddle surfboard, the paddle retaining device comprising:
a mat attachable to the paddle surfboard;
a pair of resilient bodies coupled to the mat in spaced relation to each other, each body having:
a first end portion and a second end portion, each resilient body being connected to the mat such that the first end portion extends away from the mat;
a first inlet face and a second inlet face, the distance between the first inlet face and the second inlet face decreasing in a direction extending from the first end portion toward the second end portion to define a tapered inlet channel, the inlet channel being moveable between an expanded position and a retracted position, wherein the distance between the first and second inlet faces increases as the inlet channel moves from the retracted position to the expanded position; and
an inner surface extending between the first inlet face and the second inlet face, the inner surface defining a paddle retaining channel sized to receive a portion of the paddle.

2. The paddle retaining device recited in claim 1, wherein each resilient body is integrally coupled to the mat.

3. The paddle retaining device recited in claim 1, wherein the paddle retaining channels are coaxially aligned with each other.

4. The paddle retaining device recited in claim 1, wherein at least one of the resilient bodies is formed from a rubber material.

5. The paddle retaining device recited in claim 1, wherein the mat includes an adhesive for attaching the mat to the paddle surfboard.

6. The paddle retaining device recited in claim 1, wherein at least one of the bodies includes a first peripheral wall, a second peripheral wall, and a third peripheral wall connected to the first peripheral wall and the second peripheral wall to define respective acute angles therebetween.

7. The paddle retaining device recited in claim 1, wherein the paddle retaining channel defines a semi-circular configuration.

8. A support mat and paddle retaining device for use with a paddle and a paddle surfboard, the paddle retaining device comprising:
a mat attachable to the paddle surfboard to support a user on the paddle surfboard; and
a resilient body having:
a first end portion and a second end portion;
an inlet channel formed within the resilient body extending from the first end portion toward the second end portion, the inlet channel being moveable between an expanded position and a retracted position, wherein the size of the inlet channel increases as the inlet channel moves from the retracted position to the expanded position; and
a paddle retaining channel in communication with the inlet channel, the paddle retaining device being sized to receive a portion of the paddle.

9. The paddle retaining device recited in claim 8, wherein the resilient body is integrally coupled to the mat.

10. The paddle retaining device recited in claim 8, wherein the resilient body is formed from a rubber material.

11. The paddle retaining device recited in claim 8, wherein the mat includes an adhesive for attaching the mat to the paddle surfboard.

12. The paddle retaining device recited in claim 8, wherein the resilient body includes a first peripheral wall, a second peripheral wall, and a third peripheral wall connected to the first peripheral wall and the second peripheral wall to define respective acute angles therebetween.

13. The paddle retaining device recited in claim 8, wherein the paddle retaining channel defines a semi-circular configuration.

14. A paddle retaining device comprising:
a resilient body having:
a first end portion and a second end portion;
an inlet channel formed within the resilient body extending from the first end portion toward the second end portion, the inlet channel being moveable between an expanded position and a retracted position, wherein the size of the inlet channel increases as the inlet channel moves from the retracted position to the expanded position; and
a paddle retaining channel in communication with the inlet channel, the paddle retaining device being sized to receive a portion of the paddle.

15. The paddle retaining device recited in claim 14, wherein the resilient body includes a first inlet face and a second inlet face, the distance between the first inlet face and the second inlet face decreasing in a direction extending from the first end portion toward the second end portion to define a tapered inlet channel.

16. The paddle retaining device recited in claim 14, wherein the resilient body further includes inner surface extending between the first inlet face and the second inlet face, the inner surface defining the paddle retaining channel.

17. The paddle retaining device recited in claim 14, wherein the resilient body is formed from a rubber material.

18. The paddle retaining device recited in claim 14, wherein the mat includes an adhesive for attaching the mat to the paddle surfboard.

19. The paddle retaining device recited in claim 14, wherein the resilient body includes a first peripheral wall, a second peripheral wall, and a third peripheral wall connected to the first peripheral wall and the second peripheral wall to define respective acute angles therebetween.

20. The paddle retaining device recited in claim 14, wherein the paddle retaining channel defines a semi-circular configuration.
